(19) United States
(12) Patent Application Publication
(10) Pub. No.: US 2026/0085018 A1
(43) Pub. Date: Mar. 26, 2026

(54) STRUCTURAL MEMBER

(71) Applicant: TOTO LTD., Fukuoka (JP)

(72) Inventors: Kenichi MOTOMURA, Fukuoka (JP); Ryoto TAKIZAWA, Fukuoka (JP)

(73) Assignee: TOTO LTD., Fukuoka (JP)

(21) Appl. No.: 19/309,224

(22) Filed: Aug. 25, 2025

(30) Foreign Application Priority Data
Sep. 26, 2024 (JP) 2024-167274

(51) Int. Cl. C04B 41/87; C04B 41/00; C04B 41/45

(52) U.S. Cl. CPC C04B 41/87; C04B 41/009; C04B 41/4529

(57) ABSTRACT

A structural member 10 includes a base material 100 and a protective film 200 covering the surface 110 of the base material 100. The protective film 200 includes a first part 201 exposed at an outermost surface 210 and a second part 202 located inward of the first part 201. The proportion of the monoclinic crystal structure in the first part 201 is higher than the proportion of the monoclinic crystal structure in the second part 202.

### CROSS-REFERENCE TO RELATED APPLICATION

This application is based upon and claims the benefit of priority from Japanese Patent Application No. 2024-167274 filed on Sep. 26, 2024, the entire contents of which are incorporated herein by reference.

### FIELD

The present invention relates to a structural member.

### BACKGROUND

Structural members having a protective film on the surface of a base material are used in various fields such as a semiconductor manufacturing apparatus. For example, as disclosed in Japanese Patent Laid-Open No. 2007-321183, a protective film for protecting a base material from plasma is formed on the surface of the base material forming chamber inner walls of a semiconductor manufacturing apparatus. Oxide ceramics such as yttria are used as protective films.

### SUMMARY

When base materials are repeatedly processed in a semiconductor manufacturing apparatus, the protective film degrades gradually over time. To reduce the frequency of maintenance for a semiconductor manufacturing apparatus, it is desirable that the protective film has a durability against plasma as high as possible.

The present invention has been made in view of such problems, and an object of the present invention is to provide a structural member having a protective film with high durability against plasma.

To solve the above problem, the structural member of the present invention comprises a base material and a protective film covering the surface of the base material. The protective film comprises a first part exposed at an outermost surface and a second part located inward of the first part. In the structural member, the proportion of the monoclinic crystal structure in the first part is higher than the proportion of the monoclinic crystal structure in the second part.

The experiments conducted by the present inventors have demonstrated that a protective film having a monoclinic crystal structure on its surface exhibits higher durability against plasma than a protective film having no such structure. The chemical structure of monoclinic crystal is relatively unstable, and is therefore affected by plasma and likely to undergo changes when exposed to it. Thus, it is considered that when the monoclinic crystal structure is arranged on the surface of the protective film (i.e., the first part), it is less likely that the inward second part will be affected by plasma. As a result, the entire protective film is considered to exhibit improved durability against plasma.

The monoclinic crystal structure may be present only in the first part, or in both the first and second parts. In either case, the durability of the protective film against plasma can be improved by setting the proportion of the monoclinic crystal structure in the first part to be relatively higher than that in the second part.

According to the present invention, a structural member with high durability against plasma can be provided.

### BRIEF DESCRIPTION OF THE DRAWINGS

FIG. 1 schematically illustrates a cross-section of the structural member according to the first embodiment;

FIGS. 2A, 2B, and 2C illustrate a method for producing the structural member according to the first embodiment;

FIG. 3 illustrates an analytical method using X-ray diffraction;

FIG. 4 is a graph illustrating an analytical method using X-ray diffraction:

FIG. 5 is a graph illustrating an analytical method using X-ray diffraction; and

FIGS. 6A, 6B, and 6C illustrate a method for producing the structural member according to the second embodiment.

### DETAILED DESCRIPTION

Hereinafter the present embodiment will be described with reference to attached drawings. For clarity of description, identical reference numerals are used to denote the same elements in all figures, and redundant descriptions are omitted.

The first embodiment will be described. The structural member 10 of the present embodiment is a member used for the inner wall of a process chamber of a semiconductor manufacturing apparatus, such as plasma etching apparatus (not shown). The use of the structural member 10 in the present embodiment is merely an example, and not limited to the use in semiconductor manufacturing apparatuses.

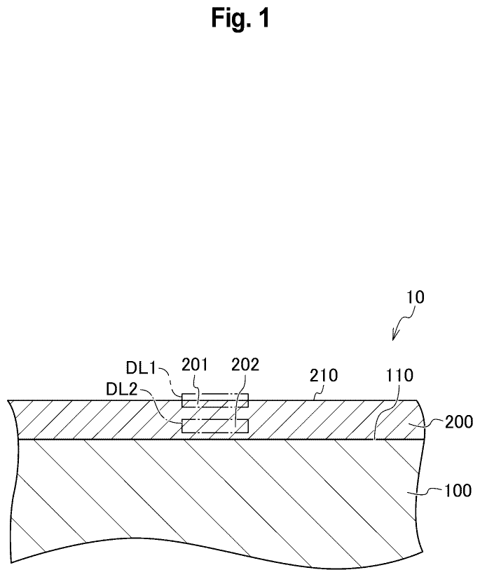

As shown in FIG. 1, the structural member 10 includes a base material 100 and a protective film 200. In a plasma etching apparatus or the like, the surface 210 of the protective film 200 is exposed to the interior of the process chamber. The protective film 200 is formed to protect the surface 110 of the base material 100 from plasma.

The base material 100 is a member forming the primary portion of the structural member 10. In the present embodiment, the base material 100 is a sintered ceramic body including high-purity aluminum oxide (Al₂O₃), but may be a different ceramic material or member other than a ceramic material (for example, a metal member). The surface 110 of the base material 100 is flat in the present embodiment, but may have irregularities or an inclined portion.

The protective film 200 is formed to protect the base material 100 from plasma as described above. The protective film 200 is formed to cover the entire surface 110 of the base material 100. In the present embodiment, the protective film 200 is configured as a film including polycrystalline yttrium oxide (Y₂O₃) as a main component, but may be a ceramic film composed of a material different from that. The thickness of the protective film 200 is appropriately adjusted depending on the duration for which durability is required to be maintained and other factors. In the present embodiment, the protective film 200 has a thickness of 10 μm.

The protective film 200 of the present embodiment is formed by a physical vapor deposition method (PVD) on the surface 110 of the base material 100 after sintering. A method for forming the protective film 200 is not limited to the physical vapor deposition method, and other methods may be used. For example, a chemical vapor deposition (CVD) method or other methods may be used to form the protective film 200.

In FIG. 1, the portion enclosed by the dash-dotted line DL1 is a part of the protective film 200 that includes the outer surface 210 (that is, on the side opposite to the base material 100). That part is also referred to as “the first part 201” below. Furthermore, the portion enclosed by the dash-dotted line DL2 in FIG. 1 is a part of the protective film 200 located inward of the first part 201 (that is, on the side closer to the base material 100). That part is also referred to as “the second part 202” below.

The dash-dotted line DL1 in FIG. 1 indicates only a part, not the entirety, of the first part 201. The first part 201 refers to the entire region of the protective film 200 that lies at the same height level as the dash-dotted line DL1 in FIG. 1. Likewise, the dash-dotted line DL2 in FIG. 1 indicates only a part, not the entirety, of the second part 202. The second part 202 refers to the entire region of the protective film 200 that lies at the same height level as the dash-dotted line DL2 in FIG. 1. The second part 202 may be a portion of the protective film 200 that is located closer to the base material 100 than the first part 201, and it may be positioned at a height different from that of the dash-dotted line DL2 in FIG. 1.

The protective film 200 of the present embodiment including the first part 201 and the second part 202 is entirely formed of the same material, i.e., a material composed of polycrystalline yttrium oxide as a main component. However, the first part 201 and the second part 202 differ from each other in their crystal structures. Specifically, the proportion of the monoclinic crystal structure in the first part 201 is higher than the proportion of the monoclinic crystal structure in the second part 202.

In each region of the protective film 200, monoclinic and cubic crystal structures are mixed. When a specific region of the protective film 200 (e.g., a region of unit volume) is observed, and the total number of crystals with a monoclinic structure contained in the region is denoted as NM, and the total number of crystals with a cubic structure contained in the region is denoted as NC, the “proportion of the monoclinic crystal structure” mentioned above can be defined as the value calculated by the formula NM/NC. To identify such relationship of magnitude, it is not necessary to calculate the proportion of the monoclinic crystal structure quantitatively and individually for each region. A method for determining the relation of magnitude without individually calculating values such as NM or NC will be described later.

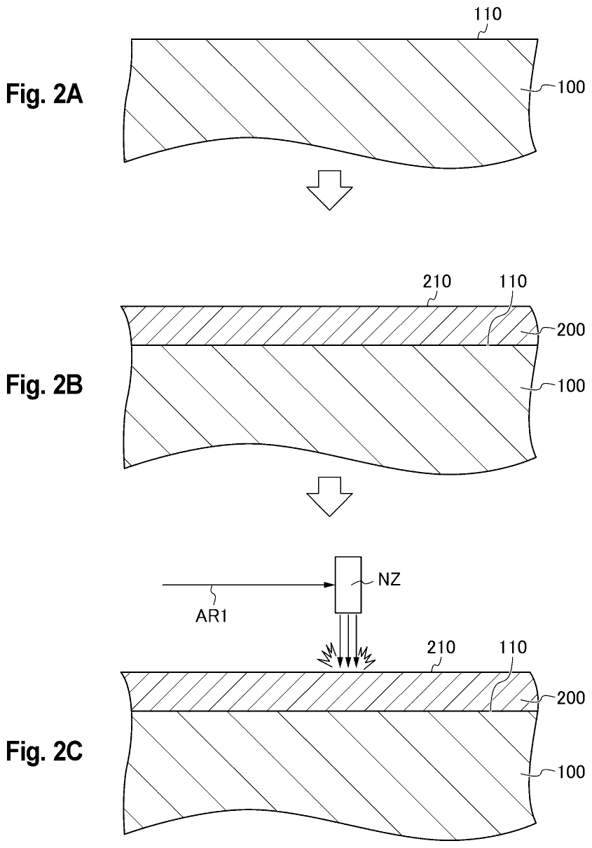

A method for producing the structural member 10 will be described with reference to FIGS. 2A, 2B, and 2C. As shown in FIG. 2A, the base material 100 is first prepared. The surface 110 of the base material 100 is preferably polished in advance to provide a smooth surface suitable for forming the protective film 200.

Next, as shown in FIG. 2B, the protective film 200 is formed so as to cover the entire surface 110. Although the protective film 200 is formed by a physical vapor deposition method (PVD) in the present embodiment as described above, other methods may also be used to form the protective film 200.

In the state shown in FIG. 2B, where the formation of the protective film 200 is complete, almost all of the yttrium oxide crystals constituting the protective film 200 have a cubic crystal structure. In other words, the yttrium oxide crystals constituting the protective film 200 contain little to no monoclinic crystal structure.

Subsequently, a treatment is performed in which an impact is applied to the surface 210 of the protective film 200. For example, as shown in FIG. 2C, by spraying a blasting material toward the surface 210 from a nozzle NZ of a sandblasting device while moving the nozzle NZ along the direction of arrow AR, the entire surface 210 can be impacted. When an impact is applied to the surface 210, a phase transition occurs in the surface 210 of the protective film 200 and its vicinity, changing part of the crystal structure from cubic to monoclinic. The intensity of the impact applied to the surface 210, such as the ejection speed of the blasting material from the nozzle NZ, may be appropriately adjusted depending on the material and thickness of the protective film 200. The ejection speed required to cause a phase transition from cubic to monoclinic crystal structure in the vicinity of the surface 210 is often lower than the ejection speed of a blasting material required to form surface irregularities on the surface 210 through sandblasting. Methods other than the above may also be used to partially induce phase transition by applying an impact to the surface 210.

Due to the impact applied to the protective film 200, the aforementioned phase transition occurs, and the monoclinic crystal structure increases in the surface 210 and its vicinity. As a result, as described above, the proportion of the monoclinic crystal structure in the first part 201 becomes higher than the proportion of the monoclinic crystal structure in the second part 202.

The experiments conducted by the present inventors have demonstrated that a protective film 200 having a monoclinic crystal structure on its surface 210 exhibits higher durability against plasma than a protective film having no such structure. The chemical structure of the monoclinic crystal is relatively unstable, and is therefore affected by plasma and likely to undergo changes when exposed to it. Thus, it is considered that when the monoclinic crystal structure is arranged on the surface 210 of the protective film 200 (i.e., the first part 201), it is less likely that the inward second part 202 will be affected by plasma. As a result, the entire protective film 200 is considered to exhibit improved durability against plasma.

A method for evaluating the “proportion of the monoclinic crystal structure” in each part of the protective film 200 will be described. As is well known, the crystal structure of the protective film 200 can be analyzed, for example, using X-ray diffraction.

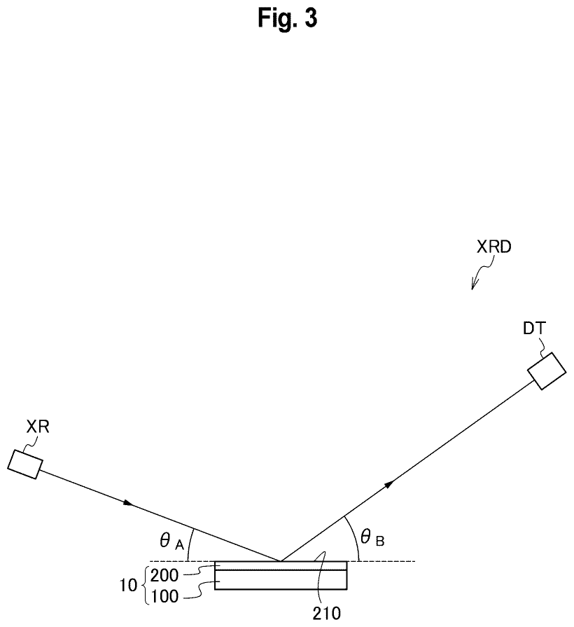

X-ray diffraction is performed using an X-ray diffraction apparatus XRD, as shown in FIG. 3. In the X-ray diffraction apparatus XRD, X-rays of a specific wavelength generated by the X-ray source XR are directed onto the surface 210 of the protective film 200, which is the measurement target. The intensity distribution, obtained by detecting the scattered light produced at the surface 210 by the detector DT, i.e., the intensity distribution of the scattered light as a function of scattering angle θ_{B} (scattering spectrum), corresponds to the crystal structure of the protective film 200. Here, the larger the incident angle θ_{A} of the X-rays relative to the surface 210, the more the obtained scattering spectrum corresponds to the crystal structure at deeper positions from the surface 210. In other words, by performing X-ray diffraction while varying the incident angle θ_{A}, the crystal structure at any depth within the protective film 200 can be investigated.

In this embodiment, “SmartLab” manufactured by Rigaku was used as the X-ray diffraction apparatus XRD. The tube voltage was set to 45 kV, the tube current to 200 mA, the scan range to 18 to 80°, the step size to 0.05°, the scan speed to 0.5°/minute, and the X-ray incident angle θ_{A} to 0.3°. The sample size was approximately 20 mm×20 mm. When the intensity of the X-ray diffraction pattern obtained by analyzing the protective film 200 using X-ray diffraction is low, it becomes difficult to distinguish between the monoclinic and cubic crystal structures. Thus, preferably the peak intensity, after subtracting the background, at the dashed line DL12 (scattering angle θ_{B} of) 29.15° should be 100 cps or higher.

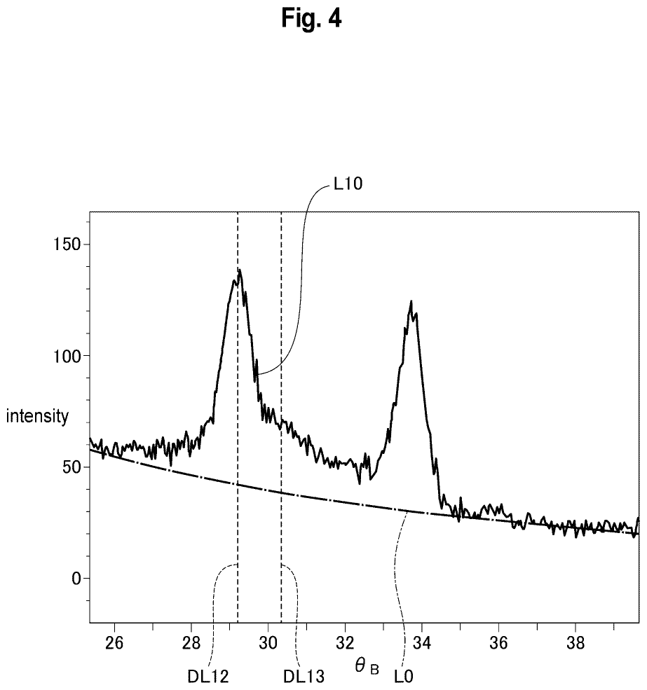

The line L10 in FIG. 4 represents an example of a diffraction pattern, i.e., a scattering spectrum, obtained by analyzing the protective film 200 using X-ray diffraction. This scattering spectrum is hereinafter also referred to as the “measured spectrum L10.” A plurality of peaks are observed in the measured spectrum L10, and each peak corresponds to the crystal structure of the material of the protective film 200. For example, the scattering angles θ_{B} corresponding to the maximum of each peak are characteristic of the crystal structure of the protective film 200. The height of each peak corresponds to the proportion of the crystal structure associated with the scattering angle θ_{B} in the protective film 200.

The dashed line DL12 shown in FIG. 4 represents a scattering angle θ_{B} of 29.15°. For example, as described in PDF 00-041-1105, when the material of the protective film 200 is yttrium oxide, as in this embodiment, and the measured portion of the protective film 200 contains a cubic crystal structure with the (222) plane present, a peak with the maximum intensity appears at a scattering angle θ_{B} of 29.15°. In other words, if the measured portion of the protective film 200 does not contain a cubic crystal structure, no peak appears at the scattering angle θ_{B} of 29.15°.

The dashed line DL13 shown in FIG. 4 represents a scattering angle θ_{B} of 30.3°. For example, as described in PDF 00-044-0399, when the material of the protective film 200 is yttrium oxide, as in this embodiment, and the measured portion of the protective film 200 contains a monoclinic crystal structure with the (40-2) plane present, a peak with the maximum intensity appears at a scattering angle θ_{B} of 30.3°. In other words, if the measured portion of the protective film 200 does not contain a monoclinic crystal structure, no peak appears at the scattering angle θ_{B} of 30.3°.

The “maximum intensity” of each peak may be used as is, as represented by the maximum intensity on the vertical axis of FIG. 4. However, to determine the proportion of the monoclinic crystal structure and the cubic crystal structure in the protective film 200 with higher accuracy, the following method is used to obtain the maximum intensity of each peak in the present embodiment.

The dash-dotted line L0 shown in FIG. 4 represents the background scattering intensity in the absence of peaks. As the scattering angle θ_{B} decreases, the background scattering intensity increases. The profile of the dash-dotted line L0 can be inferred, for example, from the overall scattering spectrum.

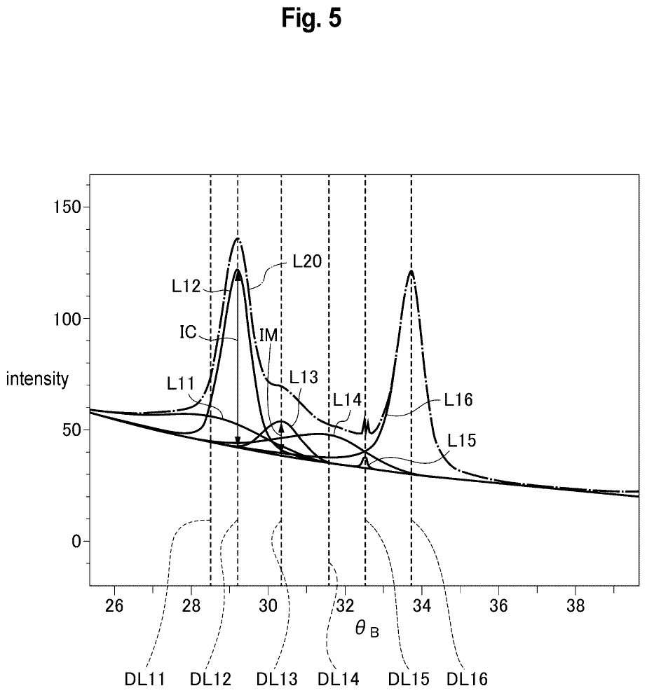

The line L11 shown in FIG. 5 represents a hypothetical scattering spectrum obtained by adding only the peak with the maximum at a scattering angle θ_{B} of DL11) (28.6°) to the background represented by the dash-dotted line L0 in FIG. 4. The same applies to the lines L12 to L16 shown in FIG. 5, each line representing a hypothetical scattering spectrum obtained by adding only the peak with the maximum at a specific scattering angle θ_{B} to the background. The scattering angle θ_{B} of DL12 is 29.15°; the scattering angle θ_{B} of DL13 is 30.3°; the scattering angle θ_{B} of DL14 is 31.5°; the scattering angle θ_{B} of DL15 is 32.5°; and the scattering angle θ_{B} of DL16 is 33.7°.

The dash-dotted line L20 shown in FIG. 5 is a scattering spectrum obtained by combining all the hypothetical scattering spectra represented by the lines L11 to L16. This scattering spectrum is also referred to as an “approximated spectrum L20” below. When combining multiple hypothetical scattering spectra, redundant background intensities are not added.

The hypothetical scattering spectra represented by the lines L11 to L16 are individually adjusted so that the profile of the approximated spectrum L20 obtained by combining them substantially matches the measured spectrum L10 shown in FIG. 4. In other words, by individually adjusting the scattering angle θ_{B} at which the peak reaches the maximum and the height of the peak relative to the background for each line such as L11, the profile of the approximated spectrum L20 is brought closer to the measured spectrum L10. When the two profiles substantially match as a result of such adjustments, each hypothetical scattering spectrum represented by the lines L11 to L16 corresponds to a profile decomposed from the measured spectrum L10 at each scattering angle θ_{B}. Such a process may be performed manually while observing the profile of the approximated spectrum L20, or may be performed automatically using the software functionality.

In the “hypothetical scattering spectrum” obtained as described above, the maximum intensity of the peak attributed to the cubic crystal structure of the (222) plane, in other words, the maximum intensity of the peak relative to the background, is also referred to as the “maximum intensity IC” below. When the material of the protective film 200 is yttrium oxide as in the present embodiment, the maximum intensity IC may be referred to as the “maximum intensity of the peak attributed to the (222) plane of cubic yttrium oxide”.

As described earlier, when the material of the protective film 200 is yttrium oxide, the scattering angle θ_{B} of the peak attributed to the (222) plane of the cubic crystal structure is 29.15°. Therefore, in the example of FIG. 5, the height of the peak shown by the line L12 is measured as the maximum intensity IC.

In the “hypothetical scattering spectrum”, the height of the peak attributed to the monoclinic crystal structure of the (40-2) plane, in other words, the height of the peak relative to the background, is also referred to as the “maximum intensity IM” below. When the material of the protective film 200 is yttrium oxide as in the present embodiment, the maximum intensity IM may be referred to as the “maximum intensity of the peak attributed to the (40-2) plane of monoclinic yttrium oxide”.

As described earlier, when the material of the protective film 200 is yttrium oxide, the scattering angle θ_{B} of the peak attributed to the (40-2) plane of the monoclinic crystal structure is 30.3°. Therefore, in the example of FIG. 5, the height of the peak shown by the line L13 is measured as the maximum intensity IM.

The ratio of the maximum intensity of the peak attributed to the (40-2) plane of the monoclinic yttrium oxide (i.e., maximum intensity IM) to the maximum intensity of the peak attributed to the (222) plane of the cubic yttrium oxide (i.e., maximum intensity IC), namely, the value of IM/IC, may be used as an indicator of the proportion of the monoclinic crystal structure in the measured portion of the protective film 200. When the structural member 10 is produced by the method described in FIGS. 2A, 2B, and 2C, the IM/IC value measured at the depth of the first part 201 is greater than the IM/IC value measured at the depth of the second part 202. That is, the proportion of the monoclinic crystal structure in the first part 201 is higher than the proportion of the monoclinic crystal structure in the second part 202.

The present inventors have found through experiments that when the IM/IC value measured on the surface 210 of the protective film 200 and its vicinity (i.e., the first part 201) is 0.2 or more, the protective film 200 exhibits sufficient durability against plasma.

To further enhance the durability of the protective film 200 against plasma, the surface 210 should preferably be as smooth as possible. Specifically, the surface 210 should preferably be polished to achieve an arithmetic mean height (Sa) of the surface 210 of 0.01 μm or less. “OLS4000” manufactured by Olympus was used as the laser microscope to examine the state of the surface 210. The magnification of the objective lens is 100×.

The second embodiment will be described. Hereinafter, the differences from the first embodiment are primarily described, while explanations of aspects common to the first embodiment are omitted where appropriate.

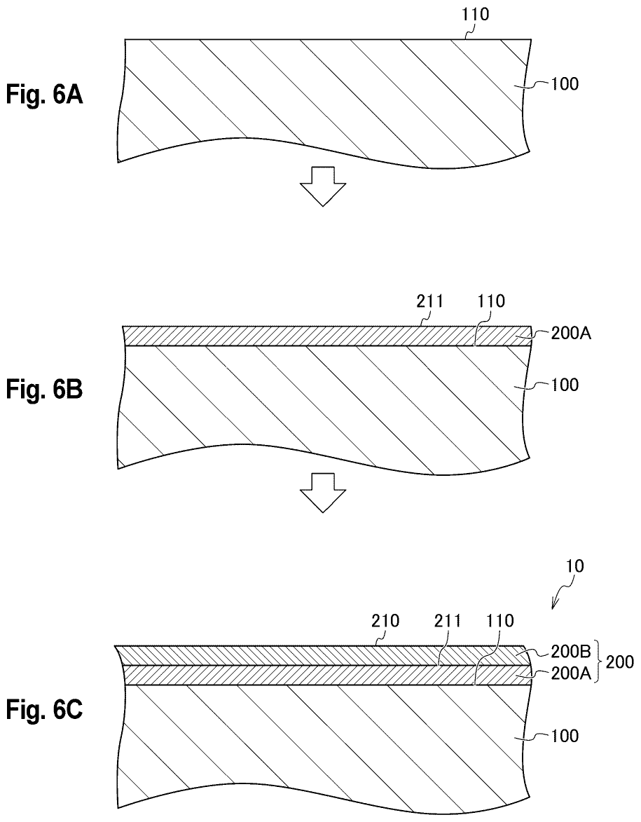

In the present embodiment, a method for forming the protective film 200 is different from that of the first embodiment. A method for producing the structural member 10 of the present embodiment will be described with reference to FIGS. 6A, 6B, and 6C. As shown in FIG. 6A, the base material 100 is first prepared. The surface 110 of the base material 100 is preferably polished in advance to provide a smooth surface suitable for forming the protective film 200.

Next, as shown in FIG. 6B, the protective film 200A is formed so as to cover the entire surface 110. The protective film 200A is composed of the same material as the protective film 200 in the first embodiment but is thinner than the protective film 200 in the first embodiment. A physical vapor deposition method (PVD) is used as the method for forming the protective film 200A.

In the state shown in FIG. 6B, where the formation of the protective film 200A is complete, almost all of the yttrium oxide crystals constituting the protective film 200A have a cubic crystal structure. In other words, the yttrium oxide crystals constituting the protective film 200A contain little to no monoclinic crystal structure.

Next, as shown in FIG. 6C, the protective film 200B is formed so as to cover the entire surface 211 of the protective film 200A. The protective film 200B is also composed of the same material as the protective film 200 in the first embodiment. An aerosol deposition method is used as the method for forming the protective film 200B. Through these steps, the protective film 200 of the present embodiment forms a two-layer structure of the protective film 200A on the side of the base material 100 and the protective film 200B on the side of the surface 210. The entire thickness is the same as the thickness of the protective film 200 in the first embodiment.

As is well known, in the aerosol deposition method, fine particles, the material of the protective film 200B, are dispersed in gas to form aerosol, which is then sprayed to the surface 211 from a nozzle to cause collision. On the surface 211, the fine particles are deformed or fragmented due to the impact of collisions, bonding to each other and gradually depositing as the protective film 200B.

The protective film 200B deposits at its surface under collision impacts from particles. Thus, the protective film 200B deposits while its crystal structure changes from cubic to monoclinic. At that stage, the same change occurs in the protective film 200A, but the proportion of the monoclinic crystal structure in the protective film 200A is smaller than the proportion of the monoclinic crystal structure in the protective film 200B.

In the protective film 200 prepared by the process described above, when part of the protective film 200B including the surface 210 is defined as the first part 201 and part of the protective film 200A is defined as the second part 202, the proportion of the monoclinic crystal structure in the first part 201 is higher than the proportion of the monoclinic crystal structure in the second part 202 in the present embodiment as well as in the first embodiment. In a configuration as in the present embodiment, where the first part 201 is formed by an aerosol deposition method and the second part 202 is formed by a physical vapor deposition method, the same effect as that described in the first embodiment can be achieved.

The present embodiment has been described with reference to examples. However, the present disclosure is not limited to these examples. Modifications made to the foregoing examples by those skilled in the art fall within the scope of the present disclosure, provided that they retain the characteristics of the present disclosure. The elements of the foregoing examples, including their configurations, conditions, shapes, and the like, are not limited to those illustrated and can be modified as appropriate. The elements of the foregoing examples can be variously combined, provided that no technical contradiction arises.

What is claimed is:

1. A structural member comprising:
a base material, and
a protective film covering a surface of the base material,
wherein the protective film comprises a first part exposed at an outermost surface and a second part located inward of the first part, and
a proportion of a monoclinic crystal structure in the first part is higher than a proportion of a monoclinic crystal structure in the second part.

2. The structural member according to claim 1, wherein the protective film comprises yttrium oxide as a main component.

3. The structural member according to claim 2, wherein, in a diffraction pattern obtained by X-ray diffraction analysis of a surface of the protective film, a value of a ratio of the maximum intensity of a peak attributed to the (40-2) plane of monoclinic yttrium oxide to the maximum intensity of a peak attributed to the (222) plane of cubic yttrium oxide is 0.2 or more.

4. The structural member according to claim 1, wherein the first part is formed using an aerosol deposition method, and the second part is formed using a physical vapor deposition method.

5. The structural member according to claim 1, wherein an arithmetic mean height of a surface of the protective film is 0.01 μm or less.
